(19) United States
(12) Patent Application Publication
(10) Pub. No.: US 2025/0329795 A1
(43) Pub. Date: Oct. 23, 2025

(54) AQUEOUS LOCALIZED HIGH-CONCENTRATION ELECTROLYTE AND PREPARATION METHOD THEREOF, AND SODIUM-ION BATTERY

(71) Applicant: Changzhou Institute of Technology, Changzhou City (CN)

(72) Inventors: Xiaohui CHEN, Changzhou City (CN); Yuxiang ZHOU, Changzhou City (CN); Hailin SHEN, Changzhou City (CN); Zhidong CHEN, Changzhou City (CN); Xueling SHAN, Changzhou City (CN); Wenchang WANG, Changzhou City (CN)

(21) Appl. No.: 18/765,555

(22) Filed: Jul. 8, 2024

(30) Foreign Application Priority Data
Apr. 23, 2024 (CN) 202410488535.1

(51) Int. Cl. H01M 10/42; H01M 4/02; H01M 4/36; H01M 4/58; H01M 4/587; H01M 10/38

(52) U.S. Cl. CPC H01M 10/4235; H01M 4/366; H01M 4/5825; H01M 4/587; H01M 10/38; H01M 2004/027; H01M 2004/028; H01M 2300/0002

(57) ABSTRACT

Disclosed are an aqueous localized high-concentration electrolyte (LHCE) and a preparation method thereof, and a sodium-ion battery, which belong to the technical field of electrolyte materials. The aqueous LHCE includes a sodium salt, water, an organic solvent, and 1,1,2,2-tetrafluoroethyl-2,2,3,3-tetrafluoropropyl ether, wherein a volume ratio of the water to the organic solvent is in a range of 1:5 to 1:7; and an amount of the 1,1,2,2-tetrafluoroethyl-2,2,3,3-tetrafluoropropyl ether in moles is not larger than an amount of the organic solvent in moles.

### CROSS REFERENCE TO RELATED APPLICATION

This patent application claims the benefit and priority of Chinese Patent Application No. 2024104885351 filed with the China National Intellectual Property Administration on Apr. 23, 2024, the disclosure of which is incorporated by reference herein in its entirety as part of the present application.

### TECHNICAL FIELD

The present disclosure relates to the technical field of electrolyte materials, and in particular to an aqueous localized high-concentration electrolyte (LHCE) and a preparation method thereof, and a sodium-ion battery.

### BACKGROUND

Water-in-salt electrolyte is an innovative technology that has attracted much research attention in the field of sodium-ion batteries in recent years. Water molecules in traditional electrolytes pose a challenge to battery stability since the water molecules could undergo side reactions with active materials in the battery, leading to decomposition of the electrolyte and degradation of battery performance. In order to solve this problem, researchers have proposed a strategy of using high-concentration salts to “wrap” the water molecules to form a water-in-salt electrolyte.

A core idea of this design is to effectively fix the water molecules through a high concentration of salts to form a special solvent sheath, thereby limiting a direct reaction between the water molecules with active materials in the battery. This method of “wrapping” water molecules helps to broaden an electrochemical stability window of the battery and improve the energy density and output power of the battery.

The introduction of water-in-salt electrolyte technology provides new ideas for solving the problems of water in sodium-ion batteries and creates better conditions for the development of sodium-ion batteries. However, water-in-salt high-concentration sodium-ion battery electrolytes face a series of challenges. For example, although high-solubility imide salts could be added to broaden the electrochemical window, there are also disadvantages brought such as high electrolyte cost, high viscosity, and poor wettability. In the prior art, researchers introduce diluents into high-concentration electrolytes to maintain localized high-concentration electrolytes (LHCEs) and reduce shortcomings such as high viscosity and poor wettability of the high-concentration electrolytes.

### SUMMARY

An object of the present disclosure is to provide an aqueous LHCE and a preparation method thereof. In the present disclosure, the aqueous LHCE has low viscosity, desirable wettability, high conductivity, and wide electrochemical stability window, and thereby could improve an electrochemical performance of the battery.

To achieve the above object, the present disclosure provides the following technical solutions:

The present disclosure provides an aqueous LHCE, including a sodium salt, water, an organic solvent, and 1,1,2,2-tetrafluoroethyl-2,2,3,3-tetrafluoropropyl ether, wherein
a volume ratio of the water to the organic solvent is in a range of 1:5 to 1:7; and
an amount of the 1,1,2,2-tetrafluoroethyl-2,2,3,3-tetrafluoropropyl ether in moles is not larger than an amount of the organic solvent in moles.

In some embodiments, a ratio of an amount of the sodium salt in moles to a total mass of the water and the organic solvent is in a range of (4-5) mol:1 kg.

In some embodiments, the sodium salt includes one selected from the group consisting of sodium perchlorate, sodium bis(trifluoromethanesulfonyl)imide, and sodium triflate.

In some embodiments, a molar ratio of the 1,1,2,2-tetrafluoroethyl-2,2,3,3-tetrafluoropropyl ether to the organic solvent is in a range of 0.3:1 to 1:1.

In some embodiments, the organic solvent includes one selected from the group consisting of N,N-dimethylformamide (DMF), sulfolane, dimethyl sulfoxide (DMSO), and glycol dimethyl ether (GDE).

The present disclosure further provides a method for preparing the aqueous LHCE as described in above technical solutions, including the following steps:
subjecting the sodium salt, the water, and the organic solvent to first mixing, and subjecting a resulting mixture and the 1,1,2,2-tetrafluoroethyl-2,2,3,3-tetrafluoropropyl ether to second mixing, to obtain the aqueous LHCE.

The present disclosure further provides a sodium-ion battery, including a positive electrode plate, a negative electrode plate, and an electrolyte, wherein the electrolyte is the aqueous LHCE as described in above technical solutions or the aqueous LHCE prepared by the method as described in above technical solutions.

In some embodiments, the positive electrode plate in the sodium-ion battery includes a first current collector, and a positive electrode coating that is coated on the first current collector, and the negative electrode plate in the sodium-ion battery includes a second current collector, and a negative electrode coating that is coated on the second current collector, wherein the positive electrode coating includes a positive electrode active material, a first conductive agent, and a first binder, and the negative electrode coating includes a negative electrode active material, a second conductive agent, and a second binder.

In some embodiments, a mass ratio of the positive electrode active material, the first conductive agent, and the first binder is in a range of (6.8-7.2):(1.8-2.2):(0.8-1.2); and a mass ratio of the negative electrode active material, the second conductive agent, and the second binder is in a range of (6.8-7.2):(1.8-2.2):(0.8-1.2).

In some embodiments, the positive electrode active material and the negative electrode active material each are a carbon-coated sodium vanadium phosphate.

The present disclosure provides an aqueous LHCE, including a sodium salt, water, an organic solvent, and 1,1,2,2-tetrafluoroethyl-2,2,3,3-tetrafluoropropyl ether, wherein a volume ratio of the water to the organic solvent is in a range of 1:5 to 1:7; and an amount of the 1,1,2,2-tetrafluoroethyl-2,2,3,3-tetrafluoropropyl ether in moles is not larger than an amount of the organic solvent in moles. In the present disclosure, the aqueous LHCE uses an organic solvent as a bridge. By adjusting dosages of water, the organic solvent, and 1,1,2,2-tetrafluoroethyl-2,2,3,3-tetrafluoropropyl ether (TTE), the TTE and the water could be miscible to form an LHCE, which reduces a sodium salt concentration in a water-in-salt electrolyte, thereby reducing viscosity of the water-in-salt electrolyte and improving wettability of the electrolyte. In this way, conductivity of the electrolyte is increased and an electrochemical performance of a battery is improved. The results of the examples show that the aqueous LHCE has a voltage window with a width of about 3.4 V at a scanning rate of 0.1 mV·S⁻¹, and could adapt to a stable operation of carbon-coated sodium vanadium phosphate as an anode and a cathode. A sodium-ion battery prepared using the aqueous LHCE has a capacity retention rate of approximately 100% after 100 cycles, indicating improved electrochemical performance of the battery.

### BRIEF DESCRIPTION OF THE DRAWINGS

FIG. 1 shows a linear voltammetry curve of the aqueous LHCE in Example 1 of the present disclosure at a scanning rate of 0.1 V·S⁻¹.

FIG. 2 shows the Raman spectra of the aqueous LHCE in Example 1 of the present disclosure and the electrolyte prepared in Comparative Example 1.

FIG. 3 shows cycle performance of the sodium-ion battery obtained in Use Example 1 of the present disclosure.

### DETAILED DESCRIPTION OF THE EMBODIMENTS

The present disclosure provides an aqueous LHCE, including a sodium salt, water, an organic solvent, and 1,1,2,2-tetrafluoroethyl-2,2,3,3-tetrafluoropropyl ether, wherein
a volume ratio of the water to the organic solvent is in a range of 1:5 to 1:7; and
an amount of the 1,1,2,2-tetrafluoroethyl-2,2,3,3-tetrafluoropropyl ether in moles is not larger than an amount of the organic solvent in moles.

In the disclosure, the term “localized high-concentration electrolyte” refers to an electrolyte that has a locally high concentration, i.e., a concentration of not less than 2 mol/L. The definition was recited in book “Na-ion Batteries Science and Technology” by Yongsheng Hu et. al, Beijing Science Press, December 2012, First edition (which is incorporated herein by reference).

In some embodiments of the present disclosure, the sodium salt includes sodium perchlorate, sodium bis(trifluoromethanesulfonyl)imide, or sodium triflate, preferably is the sodium bis(trifluoromethanesulfonyl)imide. Limiting the type of the sodium salt within above range could promote the miscibility of the diluent and the solution, thereby further improving the conductivity of the electrolyte.

In the present disclosure, a volume ratio of the water to the organic solvent is in a range of 1:5 to 1:7, preferably 1:6. Limiting the type of the mixed solvent and a volume ratio of the water to the organic solvent in the mixed solution within the above ranges could ensure subsequent miscibility with the diluent.

In some embodiments of the present disclosure, the organic solvent includes N,N-dimethylformamide (DMF), sulfolane, dimethyl sulfoxide (DMSO), or glycol dimethyl ether (GDE), more preferably is DMF. Limiting the type of the organic solvent within the above range could reduce the cost of the electrolyte.

In some embodiments of the present disclosure, a ratio of an amount of the sodium salt in moles to a total mass of the water and the organic solvent is in a range of (4-5) mol: 1 kg, preferably 4.5 mol: 1 kg. Limiting the ratio of the amount of the sodium salt in moles to the total mass of the water and the organic solvent within the above range could ensure that the electrolyte has desirable conductivity.

In the present disclosure, an amount of the 1,1,2,2-tetrafluoroethyl-2,2,3,3-tetrafluoropropyl ether in moles is not larger than an amount the organic solvent in moles. In some embodiments, a molar ratio of the 1,1,2,2-tetrafluoroethyl-2,2,3,3-tetrafluoropropyl ether to the organic solvent is in a range of 0.3:1 to 1:1, preferably 0.3:1 to 0.8:1, and more preferably 0.5:1. If the amount of the 1,1,2,2-tetrafluoroethyl-2,2,3,3-tetrafluoropropyl ether in moles exceeds that of the organic solvent, the 1,1,2,2-tetrafluoroethyl-2,2,3,3-tetrafluoropropyl ether is incompatible with water. Limiting the molar ratio of the 1,1,2,2-tetrafluoroethyl-2,2,3,3-tetrafluoropropyl ether to the organic solvent within the above range could make the 1,1,2,2-tetrafluoroethyl-2,2,3,3-tetrafluoropropyl ether miscible with the mixed solution.

In the present disclosure, an organic solvent is used as a bridge. By adjusting dosages of water, the organic solvent, and 1,1,2,2-tetrafluoroethyl-2,2,3,3-tetrafluoropropyl ether (TTE), the TTE and the water could be miscible to form an LHCE, which reduces a sodium salt concentration in a water-in-salt electrolyte, thereby reducing viscosity of the water-in-salt electrolyte and improving wettability of the electrolyte. In this way, conductivity of the electrolyte is increased and electrochemical performance of a battery is improved.

The present disclosure further provides a method for preparing the aqueous LHCE, including the following steps:
subjecting the sodium salt, the water, and the organic solvent to first mixing, and subjecting a resulting mixture and the 1,1,2,2-tetrafluoroethyl-2,2,3,3-tetrafluoropropyl ether to second mixing, to obtain the aqueous LHCE.

In the present disclosure, there are no special requirements for the first mixing. The sodium salt, water, and the organic solvent could be mixed evenly through technical solutions for preparing solutions well known to those skilled in the art.

In the present disclosure, there are no special requirements for the second mixing. The 1,1,2,2-tetrafluoroethyl-2,2,3,3-tetrafluoropropyl ether and solution system are mixed evenly through material mixing techniques well known to those skilled in the art.

The present disclosure further provides a sodium-ion battery, including a positive electrode plate, a negative electrode plate, and an electrolyte, wherein the electrolyte is the aqueous LHCE as described in above technical solutions or the aqueous LHCE prepared by the method as described in above technical solutions.

In some embodiments of the present disclosure, the positive electrode plate in the sodium-ion battery includes a first current collector, and a positive electrode coating that is coated on the first current collector; and the negative electrode plate in the sodium-ion battery includes a second current collector, and a negative electrode coating that is coated on the second current collector, wherein the positive electrode coating includes a positive electrode active material, a first conductive agent, and a first binder, and the negative electrode coating includes a negative electrode active material, a second conductive agent, and a second binder.

In some embodiments of the present disclosure, the first current collector and the second current collector each are a titanium foil.

In some embodiments of the present disclosure, the positive electrode active material in the positive electrode plate has a loading capacity of 1-1.5 mg/mm²; and the negative electrode active material in the negative electrode plate has a loading capacity of 1-1.5 mg/mm².

In some embodiments of the present disclosure, a mass ratio of the positive electrode active material, the first conductive agent, and the first binder is in a range of (6.8-7.2):(1.8-2.2):(0.8-1.2), and preferably 7:2:1. In some embodiments of the present disclosure, a mass ratio of the negative electrode active material, the second conductive agent, and the second binder is in a range of (6.8-7.2):(1.8-2.2):(0.8-1.2), and preferably 7:2: 1. Limiting the mass ratio of the positive electrode active material/the negative electrode active material, the first/second conductive agent, and the first/second binder within the above range could ensure that positive electrode slurry/the negative electrode slurry has desirable performance, thereby ensuring the performance of the battery.

In some embodiments of the present disclosure, the positive electrode active material and the negative electrode active material each are a carbon-coated sodium vanadium phosphate. Limiting the positive electrode active material/the negative electrode active material to be the above type could ensure that the battery has desirable performance.

In some embodiments of the present disclosure, a method for preparing the positive electrode plate/the negative electrode plate in the sodium-ion battery includes:
(1) mixing the positive electrode active material/the negative electrode active material, the first/second conductive agent, and the first/second binder with a solvent, and subjecting a resulting mixture to grinding and ultrasonic treatment, to obtain the positive electrode slurry/the negative electrode slurry; and
(2) applying the positive electrode slurry/the negative electrode slurry obtained in step (1) onto the current collector, drying, and then stamping to obtain the positive electrode plate/the negative electrode plate.

In the present disclosure, the positive electrode active material/the negative electrode active material, the first/second conductive agent, and the first/second binder are mixed with a solvent, and a resulting mixture is subjected to grinding and ultrasonic treatment, to obtain the positive electrode slurry/the negative electrode slurry.

In the present disclosure, there are no special limitations on types of the first/second conductive agent, the first/second binder, and the solvent, and conductive agents, binders, and solvents well known to those skilled in the art may be used. In specific examples, the first/second conductive agent is conductive carbon black; the first/second binder is polyvinylidene fluoride (PVDF); and the solvent is N-methylpyrrolidone (NMP).

In some embodiments of the present disclosure, a ratio of a mass of the positive electrode active material/the negative electrode active material to a volume of the solvent is in a range of 1 g:(4-6) mL, and preferably 1 g: 5 mL. Limiting the ratio of the mass of the positive electrode active material/the negative electrode active material to the volume of the solvent to be within the above range could obtain the positive electrode slurry/the negative electrode slurry with desirable performance, which is used for subsequent applying.

In the present disclosure, there is no special limitation on the mixing, and any mixing operations desired by those skilled in the art may be used.

In the present disclosure, there is no special limitation on the grinding, and any grinding operations desired by those skilled in the art may be used. In specific examples, the grinding is performed by manual grinding for 30 min.

In some embodiments of the present disclosure, the ultrasonic treatment is conducted for 30 min. There is no special limitation on the frequency of the ultrasonic treatment, which may be those commonly used by those skilled in the art.

In the present disclosure, the positive electrode slurry/the negative electrode slurry is applied onto the current collector, dried, and then stamped to obtain the positive electrode plate/negative electrode plate.

In the disclosure, “/” in the expressions “the positive electrode active material/the negative electrode active material”, “the first/second conductive agent”, “the first/second binder”, “the positive electrode slurry/the negative electrode slurry”, “the positive electrode coating/the negative coating”, and “the positive electrode plate/negative electrode plate” means “or”.

In some embodiments of the present disclosure, the drying is conducted in an air blast drying box and a vacuum drying oven in sequence. In some embodiments, when the drying is conducted in the air blast drying box, the drying is conducted at 60° C.; in some embodiments, the drying is conducted for 6 h. In some embodiments, when the drying is conducted in the vacuum drying oven, the drying is conducted at 90° C.; in some embodiments, the drying is conducted for 12 h. Setting the drying method and parameters within the above range could ensure that the slurries applied onto the current collectors are fully dried.

In the present disclosure, there is no special limitation on the stamping, as long as the positive electrode plate/negative electrode plate of a required size could be obtained.

The technical solutions of the present disclosure will be clearly and completely described below in conjunction with the examples of the present disclosure. Apparently, the described examples are merely a part rather than all of the examples of the present disclosure. All other examples obtained by those skilled in the art based on the examples of the present disclosure without creative efforts shall fall within the scope of the present disclosure.

### Example 1

An aqueous LHCE consisted of sodium bis(trifluoromethanesulfonyl)imide (NaTFSI), water, DMF, and 1,1,2,2-tetrafluoroethyl-2,2,3,3-tetrafluoropropyl ether.

A volume ratio of the water to the DMF was 1:6.

A molar ratio of the 1,1,2,2-tetrafluoroethyl-2,2,3,3-tetrafluoropropyl ether to the DMF was 0.5:1.

A ratio of an amount of the sodium salt in moles to a total mass of the water and the organic solvent was 4.5 mol: 1 kg.

The aqueous LHCE was prepared according to the following procedures:

The sodium bis(trifluoromethanesulfonyl)imide (NaTFSI) was mixed with the water and the organic solvent to obtain a mixture, and the mixture was mixed with the 1,1,2,2-tetrafluoroethyl-2,2,3,3-tetrafluoropropyl ether to obtain the aqueous LHCE.

The aqueous LHCE obtained in Example 1 was subjected to electrochemical testing. Before the testing, an inert gas was introduced to the electrolyte for 2 h to remove dissolved oxygen in the water. A traditional three-electrode system was constructed using a titanium foil as a working electrode, an Ag/AgCl electrode as a reference electrode, and a platinum electrode as an auxiliary electrode, and an electrochemical window of the electrolyte was measured at a scanning rate of 0.1 mV·S⁻¹.

The conductivity of the aqueous LHCE obtained in Example 1 was tested using a DDS-11A instrument, and the conductivity was 14.8 mS·cm⁻¹ at room temperature.

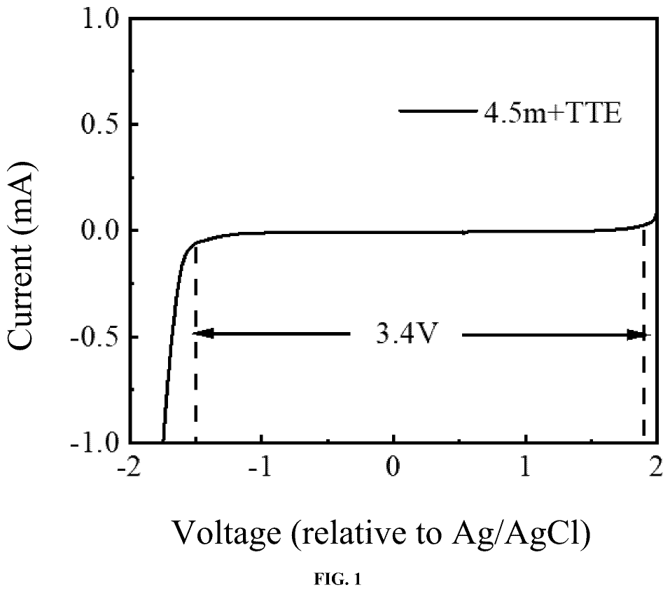

The aqueous LHCE in Example 1 exhibits a linear voltammetry curve shown in FIG. 1 at a scanning rate of 0.1 V·S⁻¹. As shown in FIG. 1, at a scanning rate of 0.1 mV·S⁻¹, the electrolyte after adding the TTE has a voltage window with a width reaching about 3.4 V, indicating that the electrolyte could adapt to a stable operation of carbon-coated sodium vanadium phosphate as an anode and a cathode.

### Comparative Example 1

Comparative Example 1 differed from Example 1 only in that the 1,1,2,2-tetrafluoroethyl-2,2,3,3-tetrafluoropropyl ether was not added, and the others were the same as those in Example 1.

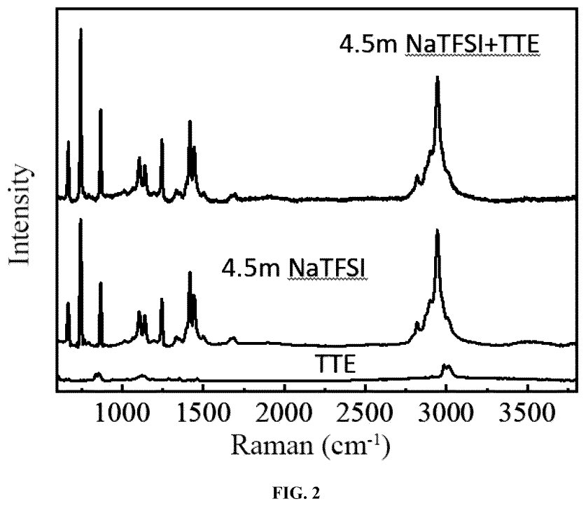

FIG. 2 shows the Raman spectra of the aqueous LHCE in Example 1 and the electrolyte prepared in Comparative Example 1. As can be seen from FIG. 2, the addition of TTE does not change a solvation structure in the solution.

The conductivity of the electrolyte obtained in Comparative Example 1 was tested using a DDS-11A instrument. The conductivity is 6 mS cm⁻¹ at room temperature.

### Comparative Example 2

Comparative Example 2 differed from Example 1 only in that a volume ratio of the 1,1,2,2-tetrafluoroethyl-2,2,3,3-tetrafluoropropyl ether to the DMF was 1.5:1, and the others were the same as those in Example 1.

The electrolyte in Comparative Example 1 was layered after adding the 1,1,2,2-tetrafluoroethyl-2,2,3,3-tetrafluoropropyl ether, making the electrolyte immiscible.

### Use Example 1

A sodium-ion battery consisted of a positive electrode plate, a negative electrode plate, and an electrolyte, wherein the electrolyte was the aqueous LHCE of Example 1.

The positive electrode plate/the negative electrode plate in the sodium-ion battery was a titanium foil, and the positive electrode coating/the negative electrode coating was applied onto the titanium foil. The positive electrode coating/the negative coating was composed of the positive electrode active material/the negative electrode active material, conductive carbon black, and PVDF. A mass ratio of the positive electrode active material/the negative electrode active material, the conductive carbon black, and the PVDF was 7:2: 1. The positive electrode active material and the negative electrode active material each were carbon-coated sodium vanadium phosphate; the positive electrode plate/negative electrode plate had a diameter of 16 mm; the loading capacity of the carbon-coated sodium vanadium phosphate on the positive electrode plate was 1.2 mg/mm², and the loading capacity of the carbon-coated sodium vanadium phosphate on the negative electrode plate was 1.1 mg/mm².

The positive electrode plate/the negative electrode plate in the sodium-ion battery was prepared according to the following procedures:
(1) The carbon-coated sodium vanadium phosphate, the conductive carbon black, and the PVDF were mixed with NMP, and a resulting mixture was manually ground for 30 min, and subjected to ultrasonic treatment for 30 min to obtain the positive electrode slurry/the negative electrode slurry, wherein a volume ratio of the carbon-coated sodium vanadium phosphate to the NMP was 1 g: 5 mL.
(2) The positive electrode slurry/the negative electrode slurry obtained in step (1) was applied onto the titanium foil, dried in an air blast drying box at 60° C. for 6 h and then in a vacuum drying oven at 90° C. for 12 h. The obtained current collectors were stamped into the positive electrode plate/the negative electrode plate, wherein the positive electrode plate/the negative electrode plate had a diameter of 16 mm.

The sodium-ion battery in Use Example 1 was subjected to a charge and discharge test in a 25° C. thermostat, with a voltage set to be 0 V to 2 V and a current density set to 1 C.

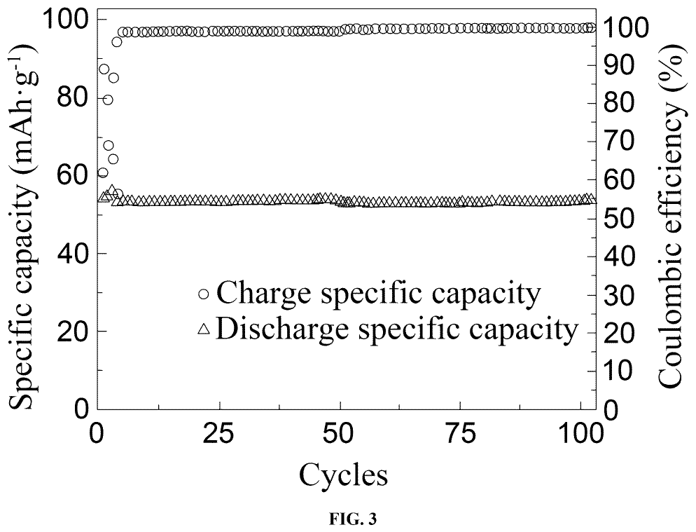

The sodium-ion battery obtained in Use Example 1 has cycle performance shown in FIG. 3. As shown in FIG. 3, a full battery prepared using the aqueous LHCE has a capacity retention rate of approximately 100% after 100 cycles.

The aqueous LHCE has a voltage window with a width of about 3.4 V at a scanning rate of 0.1 mV·S⁻¹, and could adapt to a stable operation of carbon-coated sodium vanadium phosphate as an anode and a cathode. A sodium-ion battery prepared using the aqueous LHCE has a capacity retention rate of approximately 100% after 100 cycles, indicating improved electrochemical performance of the battery.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. An aqueous localized high-concentration electrolyte (LHCE), comprising a sodium salt, water, an organic solvent, and 1,1,2,2-tetrafluoroethyl-2,2,3,3-tetrafluoropropyl ether, wherein
a volume ratio of the water to the organic solvent is in a range of 1:5 to 1:7; and
an amount of the 1,1,2,2-tetrafluoroethyl-2,2,3,3-tetrafluoropropyl ether in moles is not larger than an amount of the organic solvent in moles.

2. The aqueous LHCE as claimed in claim 1, wherein a ratio of an amount of the sodium salt in moles to a total mass of the water and the organic solvent is in a range of (4-5) mol: 1 kg.

3. The aqueous LHCE as claimed in claim 1, wherein the sodium salt comprises one selected from the group consisting of sodium perchlorate, sodium bis(trifluoromethanesulfonyl)imide, and sodium triflate.

4. The aqueous LHCE as claimed in claim 2, wherein the sodium salt comprises one selected from the group consisting of sodium perchlorate, sodium bis(trifluoromethanesulfonyl)imide, and sodium triflate.

5. The aqueous LHCE as claimed in claim 1, wherein a molar ratio of the 1,1,2,2-tetrafluoroethyl-2,2,3,3-tetrafluoropropyl ether to the organic solvent is in a range of 0.3:1 to 1:1.

6. The aqueous LHCE as claimed in claim 1, wherein the organic solvent comprises one selected from the group consisting of N,N-dimethylformamide, sulfolane, dimethyl sulfoxide, and glycol dimethyl ether.

7. A method for preparing the aqueous LHCE as claimed in claim 1, comprising the steps of subjecting the sodium salt, the water, and the organic solvent to first mixing, and subjecting a resulting mixture and the 1,1,2,2-tetrafluoroethyl-2,2,3,3-tetrafluoropropyl ether to second mixing, to obtain the aqueous LHCE.

8. The method as claimed in claim 7, wherein a ratio of an amount of the sodium salt in moles to a total mass of the water and the organic solvent is in a range of (4-5) mol: 1 kg.

9. The method as claimed in claim 7, wherein the sodium salt comprises one selected from the group consisting of sodium perchlorate, sodium bis(trifluoromethanesulfonyl)imide, and sodium triflate.

10. The method as claimed in claim 7, wherein a molar ratio of the 1,1,2,2-tetrafluoroethyl-2,2,3,3-tetrafluoropropyl ether to the organic solvent is in a range of 0.3:1 to 1:1.

11. The method as claimed in claim 7, wherein the organic solvent comprises one selected from the group consisting of N,N-dimethylformamide, sulfolane, dimethyl sulfoxide, and glycol dimethyl ether.

12. A sodium-ion battery, comprising a positive electrode plate, a negative electrode plate, and an electrolyte, wherein the electrolyte is the aqueous LHCE as claimed in claim 1.

13. The sodium-ion battery as claimed in claim 12, wherein the positive electrode plate in the sodium-ion battery comprises a first current collector, and a positive electrode coating that is coated on the first current collector, and
the negative electrode plate in the sodium-ion battery comprises a second current collector, and a negative electrode coating that is coated on the second current collector,
the positive electrode coating comprising a positive electrode active material, a first conductive agent, and a first binder, and the negative electrode coating comprising a negative electrode active material, a second conductive agent, and a second binder.

14. The sodium-ion battery as claimed in claim 13, wherein a mass ratio of the positive electrode active material, the first conductive agent, and the first binder is in a range of (6.8-7.2):(1.8-2.2):(0.8-1.2); and
a mass ratio of the negative electrode active material, the second conductive agent, and the second binder is in a range of (6.8-7.2):(1.8-2.2):(0.8-1.2).

15. The sodium-ion battery as claimed in claim 13, wherein the positive electrode active material and the negative electrode active material each are a carbon-coated sodium vanadium phosphate.

16. The sodium-ion battery as claimed in claim 14, wherein the positive electrode active material and the negative electrode active material each are a carbon-coated sodium vanadium phosphate.
